(19) United States
(12) Patent Application Publication
(10) Pub. No.: US 2005/0151727 A1
(43) Pub. Date: Jul. 14, 2005

(54) Wireless enabled touch pad pointing device with integrated remote control function

(75) Inventor: Wah Yiu Kwong, Beaverton, OR (US)

Correspondence Address: VENABLE LLP, P.O. BOX 34385, WASHINGTON, DC, 20435-9998, US

(73) Assignee: Intel Corporation, Santa Clara, CA (US)

(21) Appl. No.: 10/812,996

(22) Filed: Mar. 31, 2004

Related U.S. Application Data
(60) Provisional application No. 60/534,714, filed on Jan. 8, 2004.

(51) Int. Cl. G09G 5/08

(52) U.S. Cl. 345/173

(57) ABSTRACT

A wireless enabled touch pad pointing device with integrated remote control function may be used to eliminate a need for multiple control devices in a multimedia entertainment center of a digital home.

### BACKGROUND OF THE INVENTION

In the digital home, personal computers (i.e., PCs) and consumer electronics devices work together to deliver digital media to the parts of the home where a user would want it. The user already can enjoy the power and flexibility of digital media—taking photos with a digital camera, collecting MP3s from favorite artists, and recording TV shows on a digital hard drive. Now, with the convergence of consumer electronics and PC technology, a user can easily and conveniently enjoy this content across different network-enabled devices and locations in the user's home.

Perfect for home entertainment, the home PC is evolving into a digital media hub that brings together a user's digital media content and allows the user to access video, music and images with a remote control. PCs for the digital home come equipped with all the necessary components to deliver computing power and an enjoyable home entertainment experience.

By itself, a PC for the digital home is capable of turning any room in a user's home into a multimedia entertainment center—where a user can enjoy the convenience of remote control access for watching TV, playing DVDs, and listening to music. Combined with a digital media adapter, a user's PC for the digital home can wirelessly distribute digital video, photos and music to the user's stereo or TV. However, such remote controls do not currently include pointing devices.

### BRIEF DESCRIPTION OF THE DRAWINGS

Preferred embodiments of the invention will now be described in connection with the associated drawings, in which:

FIG. 1 depicts an orthogonal view of a first side or surface of a wireless enabled touch pad pointing device with integrated remote control function;

FIG. 2 depicts a smaller scale orthogonal view of a second side or surface of a wireless enabled touch pad pointing device with integrated remote control function; and

FIG. 3 depicts a block diagram of a multimedia entertainment center having a wireless enabled touch pad pointing device with integrated remote control function.

### DETAILED DESCRIPTION OF PREFERRED EMBODIMENTS

In the following description and claims, the terms “connected” and “coupled,” along with their derivatives, may be used. It should be understood that these terms are not intended as synonyms for each other. Rather, in particular embodiments, “connected” may be used to indicate that two or more elements are in direct physical or electrical contact with each other. In contrast, “coupled” may mean that two or more elements are in direct physical or electrical contact with each other or that the two or more elements are not in direct contact but still cooperate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Moreover, a “pointing device” may comprise any input device that is used to move the pointer on the computer screen. Examples are the mouse, stylus, trackball, pointing stick, and touch pad.

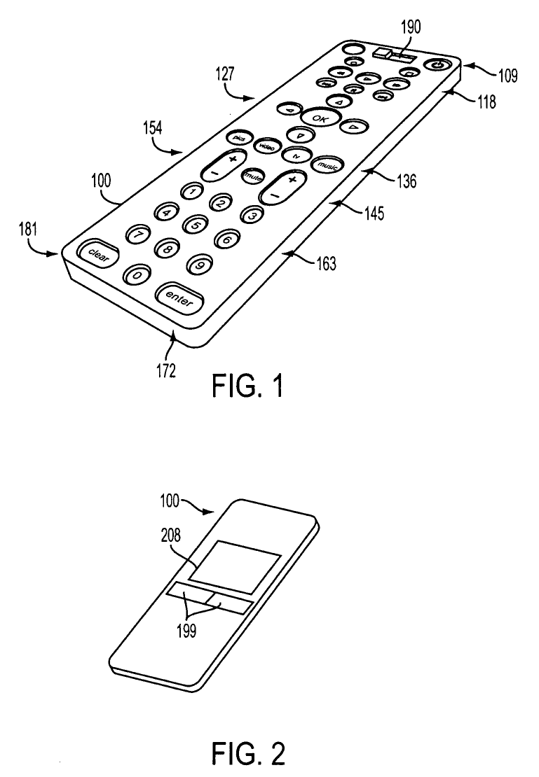

FIG. 1 depicts a system in which embodiments of the present invention may be implemented. In FIG. 1, the system may include a first side of a wireless enabled touch pad pointing device 100 with integrated remote control function. The device 100 may include means for powering the device 100 on, such as an on button 109. Since device 100 is adapted to be used in a multimedia digital home environment, it may also include a plurality of personal video recorder (i.e., PVR/VCR) control buttons 118. Similar such control buttons 118 can be conventionally used to provide a fast forward selector (e.g., four speeds: 4×, 15×, 60× or 300×), a fast reverse selector (e.g., four speeds: 4×, 15×, 60× or 300×), a skip forward selector, a skip back selector, and a pause selector. The plurality of buttons 118 may also include a stop selector and a record selector.

A second plurality of buttons 127 may also provide the means for scrolling up, down, left and right, and selecting a function by pressing an “OK” button. Media selector buttons 136 may also be provided to enable the user to select from pictures, video, television, and music. A channel up (i.e., “+”) or down (i.e., “−”) button 145 can be used to select channels on a television, while volume can be controlled by means of buttons 154 to turn the volume up (i.e., “+”) or down (i.e., “−”) and mute the sound.

A numeric keypad 163 can also be provided to input numeric data. An enter button 172, or similar such means, can be used to enter the numeric data input by use of the numeric keypad 163, while a clear button 181, or similar such means, can be used to clear such numeric data. The device 100 also may include a pair of buttons 199 (FIG. 2) on either side thereof to provide left and right mouse button means.

A switch 190 may be used to selectively toggle between operations controlled by the first side of device 100, and the second as described in greater detailed herein below. That is, in order to use the buttons on the first side of device 100, switch 190 may be slid to the left as shown in FIG. 1. The user may then slide switch 190 to the right in order to use the pointing device 208 on the second side of device 100. Right and left click mouse buttons 199 may be used only with the pointing device 208 on the second side of device 100, as controlled by the position of switch 190. Or, they may be used regardless of the position of that switch 190.

FIG. 2 depicts the other side of a wireless enabled touch pad pointing device 100 in a slightly smaller scale. Such side includes a pointing device 208, such as a touch pad.

Conventional touch pads work by sensing an electrical phenomenon called capacitance. Whenever two electrically conductive objects come near to each other without touching, their electric fields interact to form capacitance. The surface of a touch pad is a grid of conductive metal wires covered by an insulator such as Mylar® (a registered trademark owned by Dupont Teijin Films U.S. Limited Partnership of Wilmington, Del. USA). The human finger is also an electrical conductor. When a user's finger is placed on a touch pad, a tiny capacitance forms between the user's finger and the metal wires in the touch pad. Certain touch pads (e.g., those manufactured by Synaptics Incorporated of San Jose, Calif. USA) use a diamond chain pattern for the wires that maximizes capacitive contact with the user's finger. The Mylar insulator keeps the user's finger from actually touching the wires and is textured to help the user's finger move smoothly across the surface.

A touch pad's sensitive analog electronics measure the amount of capacitance in each of the wires. By seeing when the capacitance increases, the touch pad can tell when the user's finger is touching. By seeing which wires have the most capacitance, the touch pad can also locate the user's finger to an accuracy better than 1/1000th of an inch. The sensing electronics are typically inside an application specific integrated circuit (i.e., ASIC) on the back side of the touch pad. The ASIC also may include a microprocessor that computes the finger's position and speed and reports them to the main computer in the form of cursor motion. The ASIC may also detect when the user taps on the pad, and converts those taps into simulated mouse button clicks. In such a manner, the ASIC may comprise a first simulator interface to simulate mouse clicks.

Touch pads can work with any mouse driver, but a Synaptics TouchPad™, for example, works best with the Synaptics driver. When used with the Synaptics driver, a Synaptics TouchPad reports not just the mouse-like motion of the finger, but also the absolute position of the finger on the TouchPad surface as well as the amount of finger pressure. The driver uses this information to enhance the user interface in a variety of ways. For example, if the finger moves up and down along the right-hand edge of the pad, the driver can activate a “virtual scrolling” feature by way of appropriate algorithms. In such a manner, the touch pad and driver may comprise a second simulator interface to simulate scrolling. Synaptics has developed drivers for operating systems like Windows, Windows CE, Linux, and others. In addition, a general purpose TouchPad Application Programming Interface (API) is available, which allows adaptation of such touch pads into products such as cell phones and personal digital assistants (PDAs).

Capacitive sensing technology in touch pads has numerous advantages over other technologies like membrane switches and resistive sensors. Its solid-state construction makes it extraordinarily rugged. And, because a touch pad sensor is just a grid of wires, it can be made extremely thin, lightweight, flexible, or even transparent. The onboard microprocessor makes it easy to build custom touch pads for special needs.

Such proven capacitive sensing technology can also work for force sensors. In a force sensor, two metal plates are held close together, usually separated by an air gap. Force applied on the plates changes the capacitance between them. Synaptics, for example, has developed a capacitive force sensing technology suitable for applications as diverse as joysticks, vacuum gauges, high-resolution pressure sensors, and toys.

Other forms of pointing devices may be used in further embodiments of the present invention. A pointing stick, for example, may be employed. Pointing sticks can be built using capacitive force sensing technology. Like other pointing sticks, such pointing sticks sense the force of the finger applied to a small rubber cap. Where some pointing sticks use strain gauges, others measure force capacitively. The rubber cap of such pointing sticks is connected to a metal plate mounted above a capacitive sensor.

The metal plate naturally creates a capacitance with the sensor. As the user presses on the cap, the plate deforms slightly. The ASIC senses this motion and translates it into cursor motion. When the user presses down on the cap, the ASIC senses the overall change in capacitance to implement a “press-to-select” feature.

Touch pads and pointing sticks can be used together in the same device. In such a dual pointing system, the touch pad connects to the pointing stick and passes the pointing stick motion information on to the computer. This allows both devices to be used without adding any new ports to the computer hardware.

Still other forms of pointing devices may be used in still further embodiments of the present invention. Known transparent capacitive position sensing technology operates in a manner very similar to other known capacitive sensing technology. To capacitively locate a finger, sense wires are formed using transparent conductors. Most commonly, indium tin oxide (ITO) is used, and can be placed over polyester (PET), polycarbonate, glass or any viewable surface.

Further, two-dimensional transparent capacitive position sensing technology utilizes a grid of these ITO sensors to accurately locate the X, Y and “pressure” of a finger on a sensor. Typically, ITO-coated PET is etched to form a one-dimensional array of wires. Two layers of this sensor are bonded together using an optical adhesive. This provides a strong, simple, and flexible sensor that can be placed in front of a display.

The most common alternative to transparent capacitive sensing is resistive technology. In a typical resistive touchscreen, two layers of ITO-coated PET are separated by an air gap. When the screen in pressed, the top layer bends to make contact with the bottom layer. Placing a voltage gradient across the top ITO layer, and then measuring the voltage on the bottom layer can calculate the point of contact. That is, a resistive touchscreen technology is akin to a potentiometer.

This capacitive solution is utilized in the Synaptics ClearPad™ product, for example. It is completely solid state, with no moving parts. It has the durability of its rigid components. In contrast, resistive screens are physical switches that must flex and rub throughout their useful lifetime.

Because capacitance can be sensed through most materials, ClearPad designers are not limited to pliable surface materials as required by resistive sensing technology. Capacitive sensing operates even when the sensor is placed underneath a durable surface, such as polycarbonate or acrylic. In this situation, the ClearPad has the environmental durability of its rigid overlay, and allows the ClearPad to function in environments where other technologies fail. PDAs that utilize resistive technology require protective covers that must be opened before they can be used.

The ClearPad is optically simpler than the resistive touch panel. Refractive index-matched adhesives can be used, and the lack of an air gap and spacer dots provide for fewer internal reflections. Absorption of light is also minimized, because very thin ITO is used. In contrast, the physical stack-up of a resistive panel requires the use of an air gap, and steps must be taken to minimize the loss of light as it passes through layers with differing refractive indices.

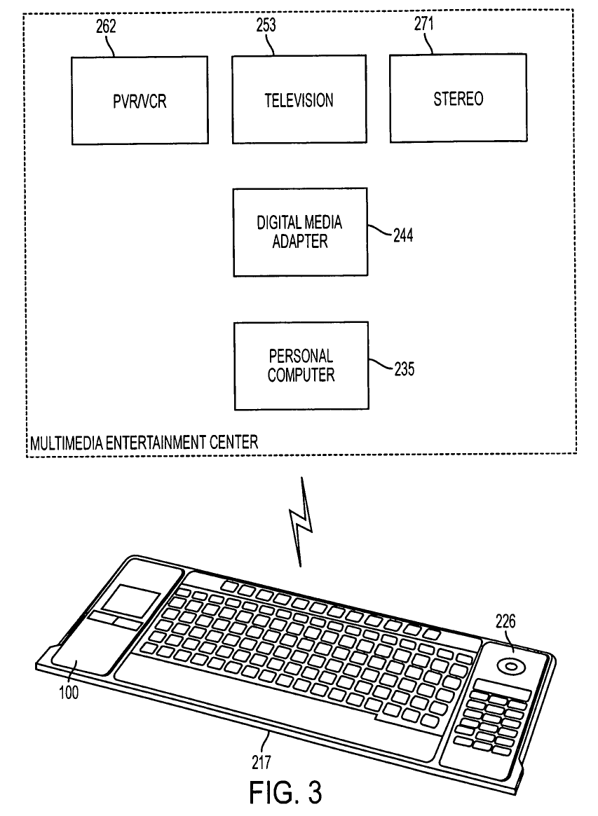

Preferably, the remote control means on the first side of the pointing device 100 according to embodiments of the present invention and the input device 208 on the second side, as well as the buttons 199 on opposing sides of the pointing device 100 are remotely coupled to a user's PC 235 (FIG. 3) by means of suitable wireless technology. One such suitable means is “Bluetooth”, which is a short-range (2.4 GHz) radio technology that simplifies communications among networked devices and between devices and the Internet. It also simplifies data synchronization between networked devices and other computers, and operates in a bi-directional mode. Because Bluetooth is not designed to carry heavy traffic loads, it is not typically a suitable technology for replacing LANs or WANs.

FIG. 3 depicts still another system in which embodiments of the present invention may be implemented. In FIG. 3, the system may include not only a wireless enabled touch pad pointing device 100 with integrated remote control function, but also a Bluetooth-enabled wireless keyboard 217. Conveniently, the wireless enabled touch pad pointing device 100 may be formed to fit within a cradle in the keyboard 217 in the manner shown in FIG. 3. The cradle may be adapted to transmit Bluetooth signals from the wireless enabled touch pad pointing device 100 to the PC 235. Additionally, the wireless keyboard 217 may be adapted to charge rechargeable batteries (not shown) within the wireless enabled touch pad pointing device 100 in a conventional manner. Thus, the wireless enabled tough pad pointing device 100 may be used either within or outside of its cradle. A wireless numeric keypad 226 may be similarly cradled and adapted for use in the wireless keyboard 217.

Signals between the wireless enabled touch pad pointing device 100, wireless keyboard 217, wireless numeric keypad 226, and PC 235 may be easily used to control a multimedia entertainment center. According to one embodiment, the PC 235 itself may comprise the multimedia entertainment center. One such suitable PC 235 may include an Intel® Pentium® 4 Processor with HT Technology (i.e., a technology which allows the processor to execute two threads or parts of a software program in parallel, so that a user's software can run more efficiently and the user can multitask more effectively), an Intel® 875P chipset, and an Intel® Desktop Board D875PBZ. Such a PC 235 would, thus, support an 800-MHz system bus with dual channel DDR400 and native Serial-ATA 150 with Intel® RAID Technology. The PC 235 may also include a wireless PCI adapter, which facilitates transfer of media from the user's PC 235 to a TV 253 and stereo 271 and to other PCs. It may also include a display and a single TV tuner PCI card, which enables the PC 235 to receive TV signals and thereby function both as a TV and Personal Video Recorder (PVR). Finally, the PC 235 may include a multi-channel audio system with high-end speakers, including a sub-woofer.

Alternatively, the PC 235 may be coupled to a digital media adapter 244 that enables a PC 235 in the home to wirelessly distribute digital content such as photos and music to networked consumer electronic devices such as a TV 253 or stereo 271. In this manner, the multimedia entertainment center may also include a PVR/VCR 262.

The digital media adapter 244 will act as a wireless bridge between the PC 235 and the TV 253 or stereo 271. It uses standard audio/video cables to connect to the TV 253 and stereo 271, and wireless networking to communicate with the PC 235. The PC 235 will do all the hard work of processing and distributing the digital media throughout the home, while the adapter 244 will simply pass along those signals to the TV 253 and stereo 271. This setup will allow the adapter 244 to remain low cost while providing the consumer with a high-quality experience. Examples of suitable such digital media adapters 244 are the Pinnacle ShowCenter from Pinnacle Systems, Inc. of Irvine, Calif. USA, the Linksys Wireless-B Media Adapter (WMA11B) from Linksys, a division of Cisco Systems Inc. of Irvine, Calif. USA, and the Play@TV™ NMP-4000 Network Media Player from icube & seizenet Corp. of Seoul, South Korea.

Embodiments of the present invention may include apparatuses for performing the operations herein. An apparatus may be specially constructed for the desired purposes, or it may comprise a general-purpose device selectively activated or reconfigured by a program stored in the device.

Embodiments of the invention may be implemented in one or a combination of hardware, firmware, and software. Embodiments of the invention may also be implemented with instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, etc.), and others.

The invention has been described in detail with respect to various embodiments, and it will now be apparent from the foregoing to those skilled in the art that changes and modifications may be made without departing from the invention in its broader aspects. The invention, therefore, as defined in the appended claims, is intended to cover all such changes and modifications as fall within the true spirit of the invention.

1. A pointing device, comprising:
a first surface including an interface to control a multimedia entertainment center having a personal computer and a display; and
a second surface, opposite said first surface, including an input device to remotely move a pointer on the display.

2. The pointing device according to claim 1, further comprising first and second select buttons coupled to the input device.

3. The pointing device according to claim 1, wherein the input device comprises a touch pad.

4. The pointing device according to claim 3, wherein the touch pad comprises a capacitive-sensing touch pad.

5. The pointing device according to claim 4, wherein the capacitive-sensing touch pad further comprises a first simulator interface to simulate mouse clicks.

6. The pointing device according to claim 4, wherein the capacitive-sensing touch pad further comprises a second simulator interface to simulate scrolling.

7. The pointing device according to claim 4, wherein the capacitive-sensing touch pad comprises a transparent capacitive-sensing touch pad.

8. The pointing device according to claim 2, further comprising a pointing stick on the first surface to remotely move the pointer on the display.

9. The pointing device according to claim 8, further comprising an interlock to cooperatively control inputs from the pointing stick on the first surface and the input device on the second surface.

10. The pointing device according to claim 8, wherein the input device, the pointing stick and the select buttons are coupled to the personal computer by a wireless interface.

11. The pointing device according to claim 10, wherein the wireless interface comprises a Bluetooth interface.

12. The pointing device according to claim 1, wherein the input device and the select buttons are coupled to the personal computer by a wireless interface.

13. The pointing device according to claim 12, wherein the wireless interface comprises a Bluetooth interface.

14 A multimedia entertainment center, comprising:
a personal computer;
a display; and
a pointing device, the pointing device including:
a first surface including a plurality of control buttons to control the personal computer and a display of the multimedia entertainment center;
a second surface, opposite said first surface, including an input device to remotely move a pointer on the display

15. The multimedia entertainment center according to claim 14, further comprising first and second select buttons coupled to the input device.

16. The multimedia entertainment center according to claim 14, wherein the input device comprises a touch pad.

17. The multimedia entertainment center according to claim 16, wherein the touch pad comprises a capacitive-sensing touch pad.

18. The multimedia entertainment center according to claim 17, wherein the capacitive-sensing touch pad further comprises a first simulator to simulate mouse clicks.

19. The multimedia entertainment center according to claim 17, wherein the capacitive-sensing touch pad further comprises a second simulator to simulate scrolling.

20. The multimedia entertainment center according to claim 17, wherein the capacitive-sensing touch pad further comprises a transparent capacitive sensor.

21. The multimedia entertainment center according to claim 15, further comprising a pointing stick on the first surface to remotely move a pointer on the display.

22. The multimedia entertainment center according to claim 21, further comprising a controller to cooperatively control inputs from the pointing stick on the first surface and the input device on the second surface.

23. The multimedia entertainment center according to claim 21, wherein the input device, the pointing stick and the select buttons on opposing sides of the pointing device are wirelessly coupled to the personal computer.

24. The multimedia entertainment center according to claim 14, further comprising a switch to selectively control operations on the first surface and the second surface.

25. The multimedia entertainment center according to claim 14, further comprising a wireless keyboard having a cradle formed to cradle the pointing device and enable the input device to remotely move the pointer on the display.
